(19) United States
(12) Patent Application Publication
(10) Pub. No.: US 2025/0234123 A1
(43) Pub. Date: Jul. 17, 2025

(54) PIVOTING HEADSET POSITIONING ASSEMBLY AND HEADSET INTERFACE WITH ROTATABLE CONNECTOR

(71) Applicant: WILCOX INDUSTRIES CORP., Newington, NH (US)

(72) Inventors: James W. Teetzel, Portsmouth, NH (US); Elliott S. Turner, Newmarket, NH (US); Robert E. Riel, Raymond, NH (US); Robert A. Wells, Newmarket, NH (US)

(21) Appl. No.: 18/954,745

(22) Filed: Nov. 21, 2024

Related U.S. Application Data
(60) Provisional application No. 63/621,230, filed on Jan. 16, 2024.

(51) Int. Cl. H04R 1/10

(52) U.S. Cl. CPC H04R 1/105; H04R 1/1008; H04R 1/1066; H04R 2201/103; H04R 2201/107; H04R 2420/07; H04R 2420/09

(57) ABSTRACT

A headset mounting system comprises a side shroud configured to be attached to a side of a helmet, the side shroud including a mounting receptacle. A headset assembly has a mounting plug which is configured to be detachably coupled to the mounting receptacle. The mounting plug comprises a cylindrical stub having one or more lugs. A retaining collar is disposed within the mounting receptacle and has one or more slots formed therein. At least a portion of the mounting plug is configured to fit within the collar of the receptacle when the one or more lugs are aligned with the one or more slots. The plug is configured to be rotated within the collar so that the one or more lugs engage behind the collar to secure the plug within the receptacle. In a further aspect, a headset mounting interface is provided.

### CROSS REFERENCE TO RELATED APPLICATION

This application claims the priority benefit of U.S. Provisional Patent Ser. No. 63/621,230 filed Jan. 16, 2024. The aforementioned application Application is incorporated herein by reference in its entirety.

### BACKGROUND

The present disclosure relates to communication headsets and, more particularly to a headset positioning assembly for a helmet-mounted headset and a headset interface which provide quick attachment and detachment and pivoting or rotating movement of an associated headset.

### SUMMARY

A communications headset positioning assembly can be detachably coupled to a modular helmet accessory attachment system or platform. The modular helmet accessory platform includes a side shroud which includes a powered headset attachment receptacle or socket. The attachment receptacle detachably receives a complementary plug on a headset positioning assembly. The plug is configured for rotational movement within the socket, allowing movement of the headset assembly between a deployed position and a stowed position. The plug includes a plurality of contact pins configured to establish and maintain electrical contact with annular contact rings disposed on a printed circuit board (PCB) housed within the side shroud. The contact rings serve as electrical pathways for transmitting signals between an associated headset on the headset positioning assembly and the modular helmet accessory platform. The contact pins maintain electrical contact with the contact rings by riding on the rings during pivoting movement.

In another aspect, a rotatable headset positioning interface is provided.

One advantage of the present development is that it allows a headset to be readily attached to and detached from a helmet.

Another advantage of the present development is that it allows a headset to be readily pivoted between a deployed position over the user's ear when the headset is in use and a stowed position over the helmet when the headset is not in use.

Another advantage of the present development resides in its ability to maintain electrical contact between the headset and the helmet accessory attachment system when the headset positioning assembly is reoriented between the deployed and stowed positions.

Still further advantages and benefits of the present invention will become apparent to those of ordinary skill in the art upon reading and understanding the following

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1 is an isometric view of a helmet having a headset positioning assembly in accordance with a first exemplary embodiment attached thereto, taken generally from the front, (wearer's) left side, and above.

FIG. 2 is left side view of the helmet with the headset positioning assembly appearing in FIG. 1.

FIG. 3 is a partially exploded isometric view of the helmet with the headset positioning assembly appearing in FIG. 1, with the headset positioning assembly in the attachment orientation and ready to be attached, taken generally from the front and left side.

FIG. 4 is an isometric view of the helmet with the headset positioning assembly with the headset positioning assembly in the attachment orientation as shown in FIG. 3, immediately after attaching the headset positioning assembly.

FIG. 5 is an isometric view of the helmet with the headset positioning assembly as shown in FIG. 4, with the headset positioning assembly shown pivoted to the deployed position.

FIG. 6 is a left side view of the helmet with the headset positioning assembly as shown in FIG. 4, with the headset positioning assembly shown pivoted to the stowed position.

FIG. 7 is an enlarged left side view of an exemplary helmet side shroud assembly with the headset positioning assembly removed.

FIG. 8 is an enlarged right side view of the headset positioning assembly appearing in FIG. 1, with the earpiece subassembly attached thereto and the earpiece removed for ease of illustration.

FIG. 9 is an enlarged right side view of the interface plug and interface socket, in the attach/detach position.

FIG. 10 is an enlarged right side view of the interface plug and interface socket, in the deployed position.

FIG. 11 is an enlarged right side view of the interface plug and interface socket, in the stowed position.

FIG. 12 is an exploded view of the headset positioning assembly and side shroud, taken generally from the right side, the rear, and above.

FIG. 13 is an enlarged isometric view of the circuit board and the interface plug portion of the helmet positioning assembly.

FIG. 14 is an enlarged view of the circuit board ring contacts on the circuit board and relative pin locations within the interface plug, depicting an exemplary electrical layout of the headset positioning assembly and interface.

FIG. 15 is a schematic block diagram illustrating an exemplary embodiment of the electronic components of the helmet side shroud.

FIG. 16 is a schematic block diagram illustrating an exemplary communications headset operable with the side shroud interface in accordance with the present disclosure.

### DETAILED DESCRIPTION OF THE PREFERRED EMBODIMENT(S)

Reference will now be made in detail to presently preferred embodiments of the invention, one or more examples of which are illustrated in the accompanying drawings. Each example is provided by way of explanation of the invention, not limitation of the invention, which may be embodied in various forms. Therefore, specific structural and functional details disclosed herein are not to be interpreted as limiting but merely as a basis for the claims and as a representative basis for teaching one skilled in the art to variously employ the present inventive concept in virtually any appropriately detailed structure. Further, the terms and phrases used herein are not intended to be limiting but rather to provide an understandable description of the present development. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention cover such modifications and variations as come within the scope of the appended claims and their equivalents.

The terms “a” or “an,” as used herein, are defined as one or more than one. The term “another,” as used herein, is defined as at least a second or more. The terms “including” and/or “having” as used herein, are defined as comprising (i.e., open transition). The term “coupled” or “operatively coupled,” as used herein, is defined as indirectly or directly connected.

As used in this application, the terms “front,” “rear,” “upper,” “lower,” “upwardly,” “downwardly,” “left,” “right,” and other orientation descriptors are intended to facilitate the description of the exemplary embodiment(s) of the present invention and are not intended to limit the structure thereof to any particular position or orientation.

All numbers herein are assumed to be modified by the term “about,” unless stated otherwise. The recitation of numerical ranges by endpoints includes all numbers subsumed within that range (e.g., 1 to 5 includes 1, 1.5, 2, 2.75, 3, 3.80, 4, and 5).

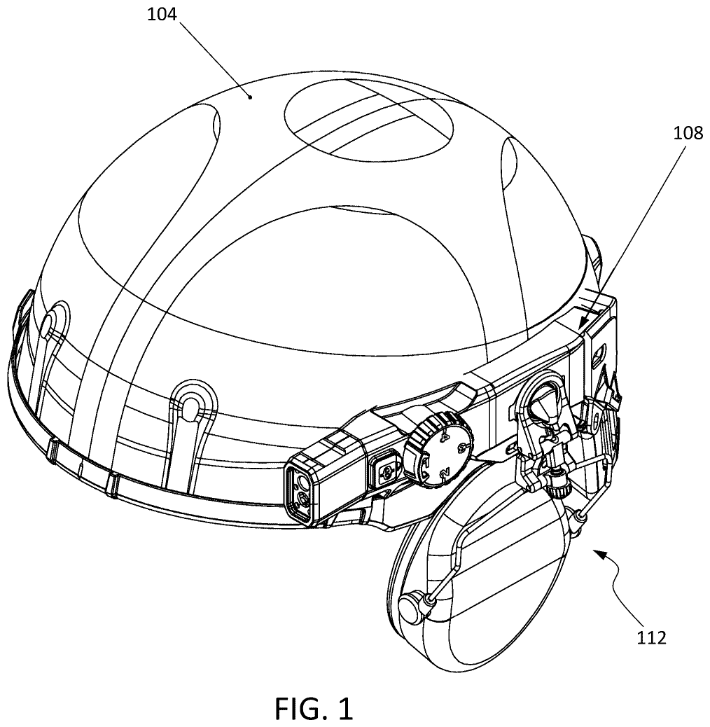

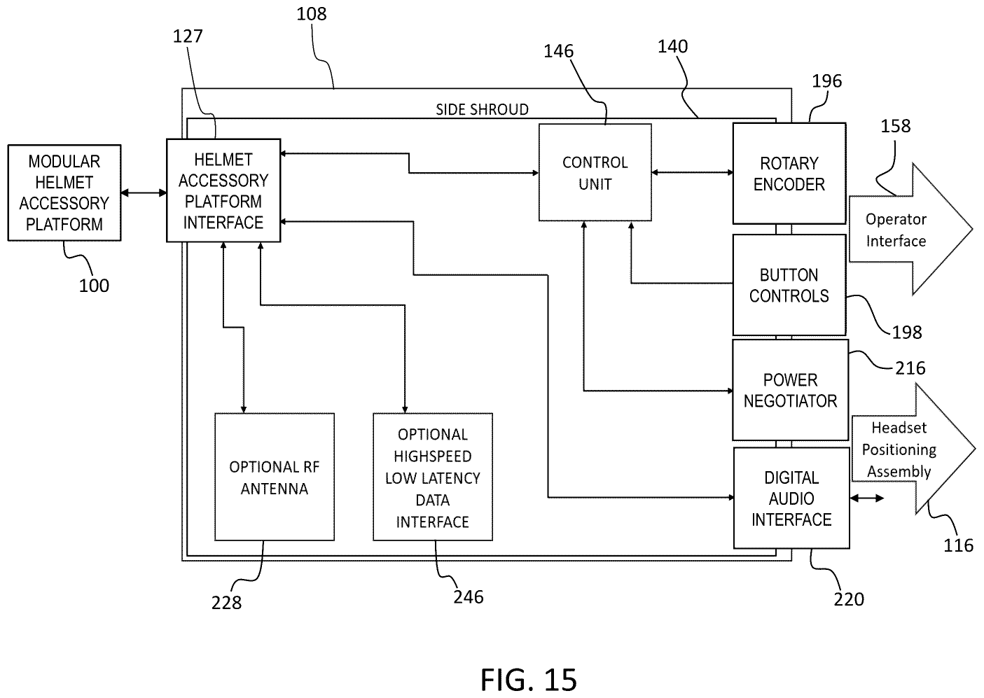

Referring now to the drawings, wherein like reference numerals refer to like or analogous components throughout the several views, FIG. 1 illustrates a helmet 104 having a side accessory mounting shroud 108 attached thereto. The shroud 108 has a housing 110. A headset assembly 112, in turn, is detachably coupled to the shroud 108. Although a left side shroud 108 is illustrated, it will be recognized that the present development can be adapted for use with a right side shroud or with both left and right side shrouds. The helmet 104 may be a military helmet, ballistic helmet, field helmet, tactical helmet, combat helmet, aviation helmet, among others. In embodiments, the side shroud 108 is a component of a helmet accessory mount platform 100 (see FIG. 15), such as shown and described in commonly owned U.S. patent application Ser. No. 18/500,657 filed Nov. 2, 2023, and U.S. provisional patent application No. 63/427,496 filed Nov. 23, 2022.

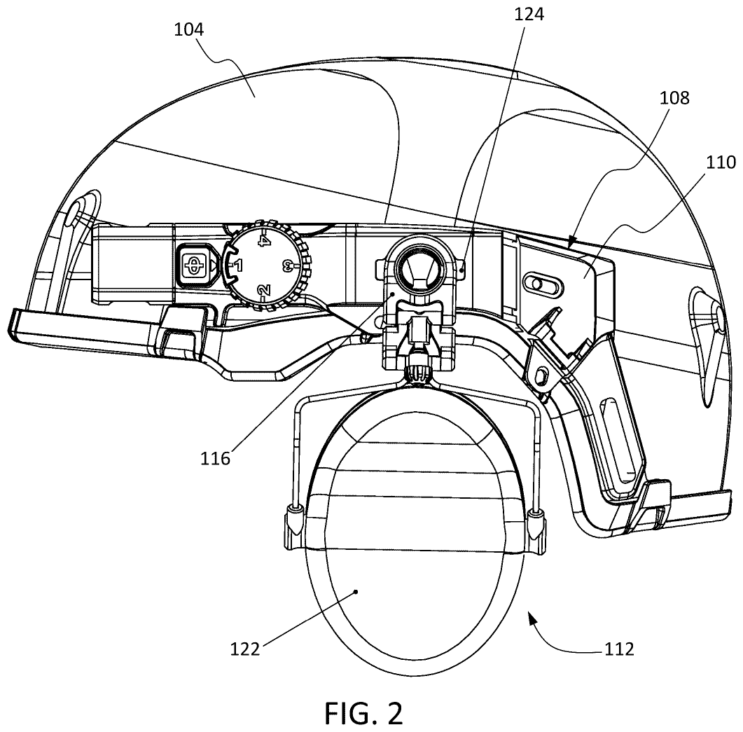

Referring now to FIG. 2, and with continued reference to FIG. 1, the headset assembly 112 includes a headset positioning assembly 116 and an earpiece assembly 118. The earpiece assembly 118 includes an earpiece 122. In the illustrated embodiment, the carpiece 122 is an ear cup, e.g., a circumaural ear cup. Although the illustrated earpiece 122 is illustrated as a circumaural ear cup having a cushion 224 in accordance with a preferred embodiment, it will be recognized that other types of headphone carpiece devices are contemplated, such as supra-aural headphone, on-car headphone, bone conduction headphone, open-back headphone, hearing protector, noise cancellation device, and the like.

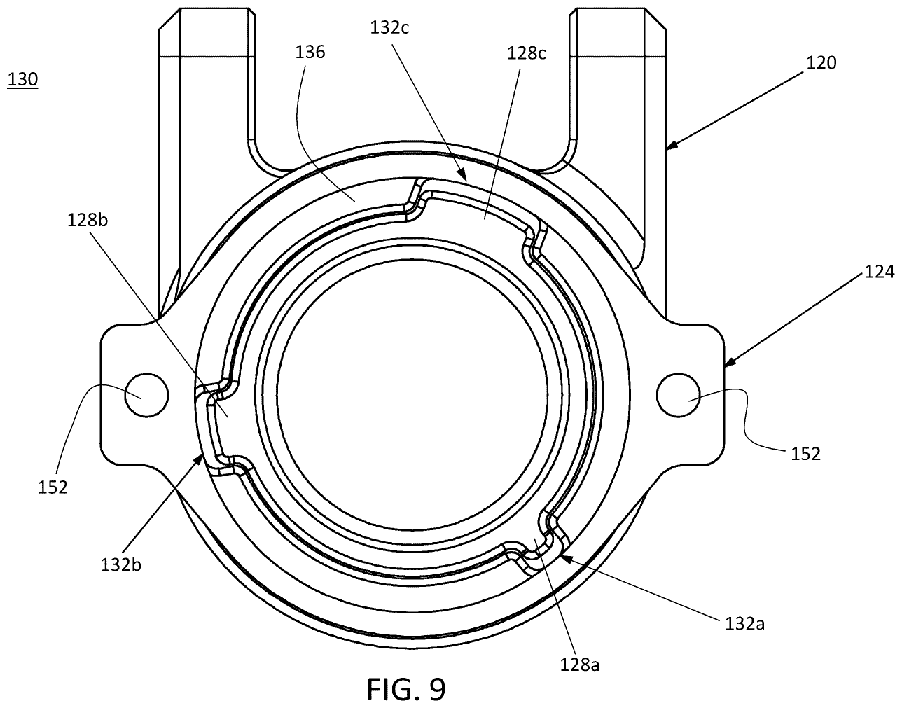

The headset positioning assembly 116 includes an interface plug 120 which detachably engages an interface receptacle or socket 124 on the shroud 108. The interface plug 120 cooperates with the interface socket 124 to define a headset assembly coupling interface 130 (see FIGS. 9-11). In the illustrated embodiment, the coupling interface 130 comprises a bayonet coupling or align-and-twist coupling.

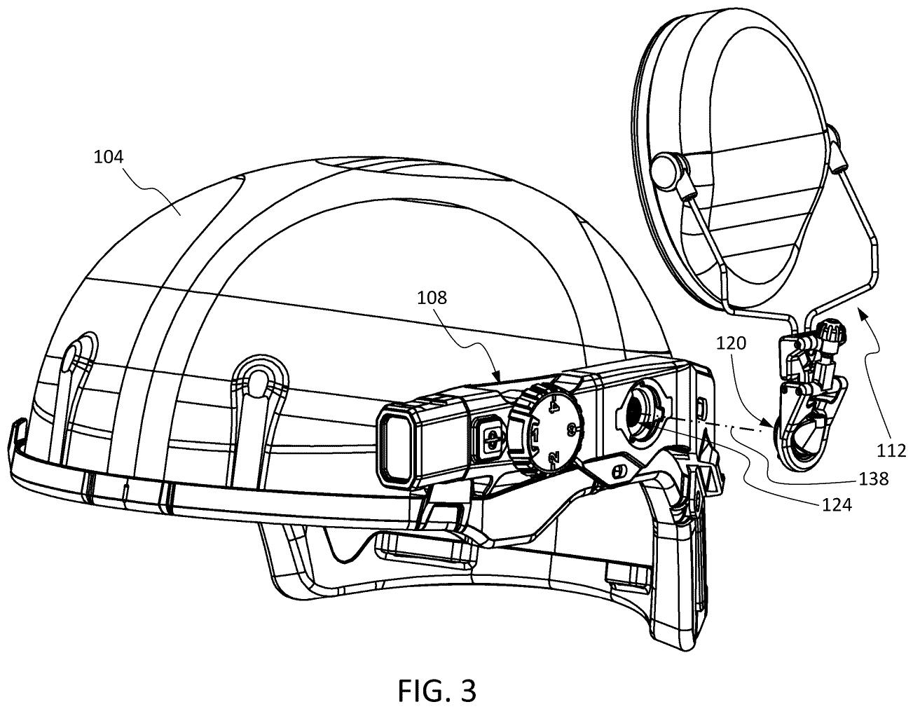

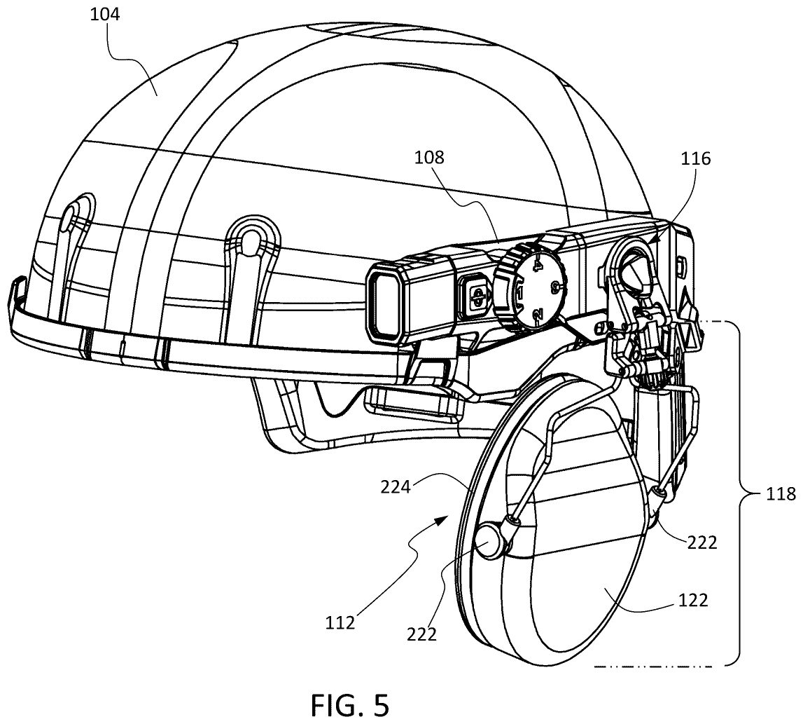

As best seen in FIGS. 3-5, and with continued reference to FIGS. 1 and 2, in order to couple the headset assembly 112 to the side shroud 108, the headset assembly 112 is inverted generally 180 degrees with respect to the deployed position shown in FIGS. 1 and 2. When the headset assembly 112 is in the inverted position, lugs 128a, 128b, and 128c are aligned with complementary notches or slots 132a, 132b, and 132c, respectively, formed in a locking collar 136. In the illustrated embodiment, the lugs 128a, 128b, and 128c have different sizes to provide a keyed configuration. Because the size of each lug/slot pair is different, the interface plug 120 can only be inserted into the interface socket in one orientation. Other keyed mechanisms are also contemplated, such as providing distinct lug and slot sizing, keyed shapes, asymmetric angular spacing, and so forth.

In operation, when the headset assembly 112 is in the inverted position as shown in FIG. 3, the lugs 128a, 128b, and 128c move past the respective slots 132a, 132b, and 132c in the axial direction when the interface plug 120 is inserted into the interface socket 124 on the shroud 108. The headset assembly 112 is then pivoted 180 degrees about a pivot axis 138 until the headset assembly 112 is in the deployed position as shown in FIGS. 1, 2 and 5. In the deployed position, the lugs 128a-128c are trapped behind the collar 136 to provide a secure connection of the headset assembly 112 to the side shroud 108. In certain embodiments, one or more alignment mechanisms can be utilized to achieve the desired deployed and stowed orientations. In certain embodiments, the one or more alignment mechanisms include one or more spring loaded detents on the interface plug 120 configured to engage with one or more complementary features on the interface socket 124, or vice versa. Other alignment mechanisms include cam mechanisms, physical rotational stops, indexing pins, and the like, and combinations thereof.

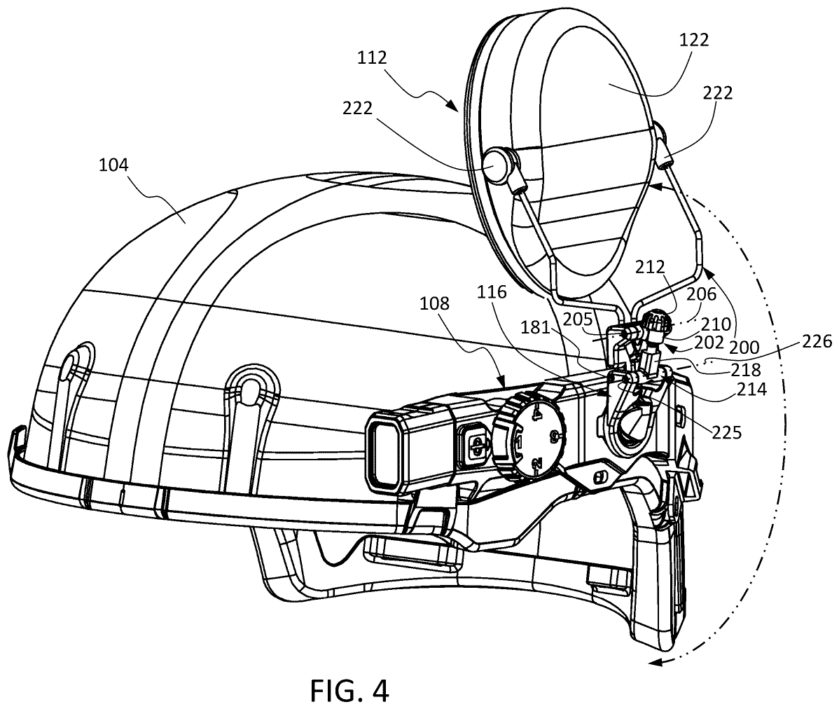

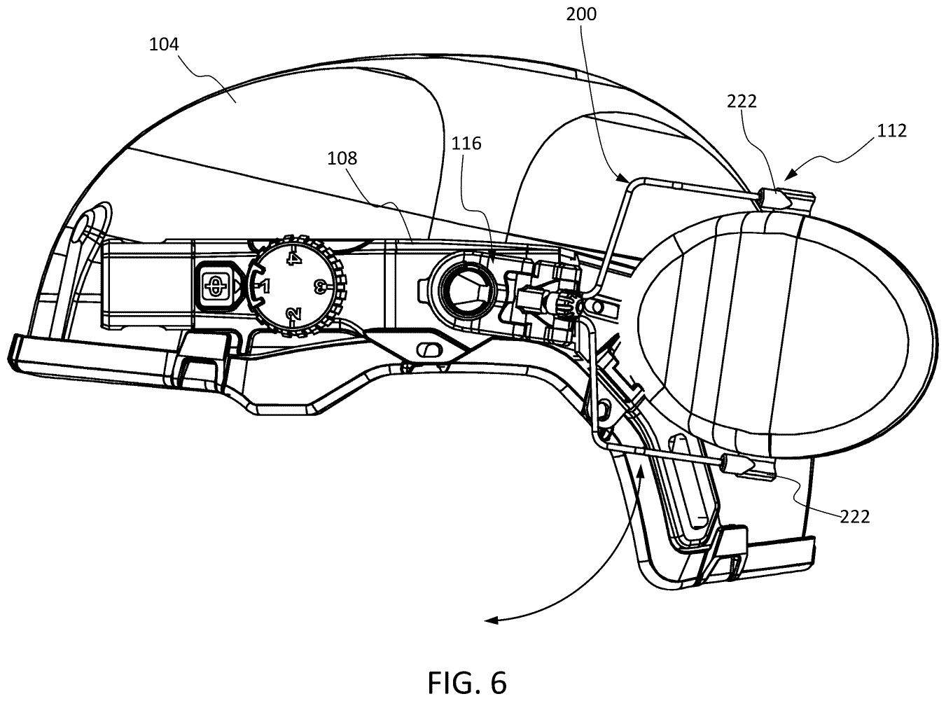

As best seen in FIG. 6, and with continued reference to FIGS. 1-5, the headset assembly coupling interface 130 is configured to allow the headset assembly 112 to be pivoted to a stowed position which is intermediate the deployed position as seen in FIGS. 1, 2, and 5, and the inverted attach/detach position as shown in FIG. 4. The stowed position is advantageous for certain situations when it is desirable or advantageous to temporarily remove the headset earpiece, such as for better hearing of ambient or environmental sounds, verbal commands, potential threats, or information or communications from teammates that occur in the user's immediate vicinity. The stowed position is also useful for use on extended missions, periods of downtime, and relief from overheating and discomfort associated with prolonged use when removal of the headset assembly 112 from the helmet 104 is not desired.

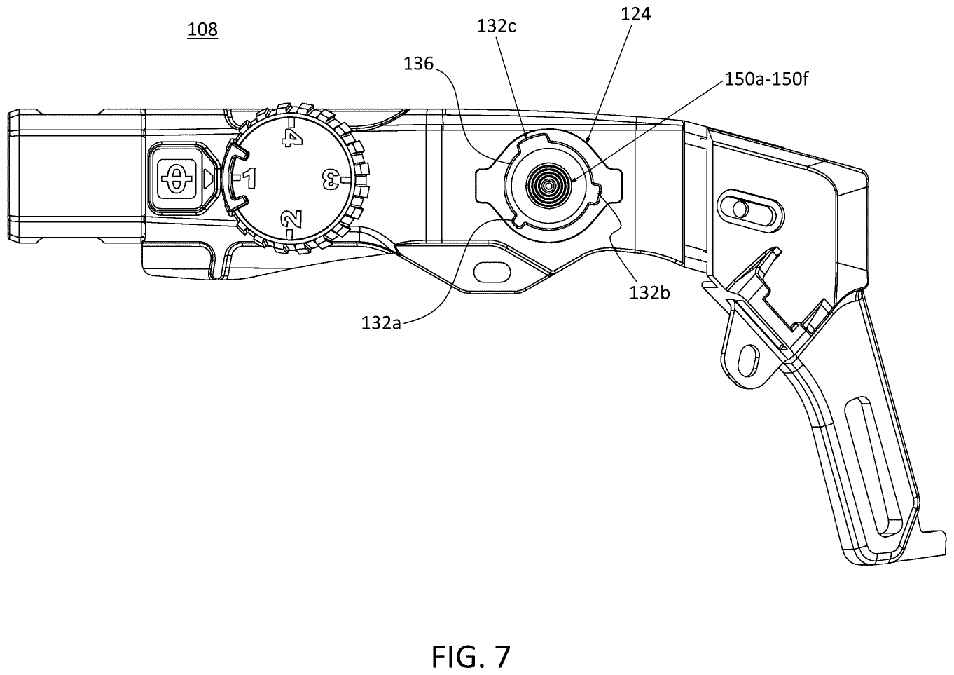

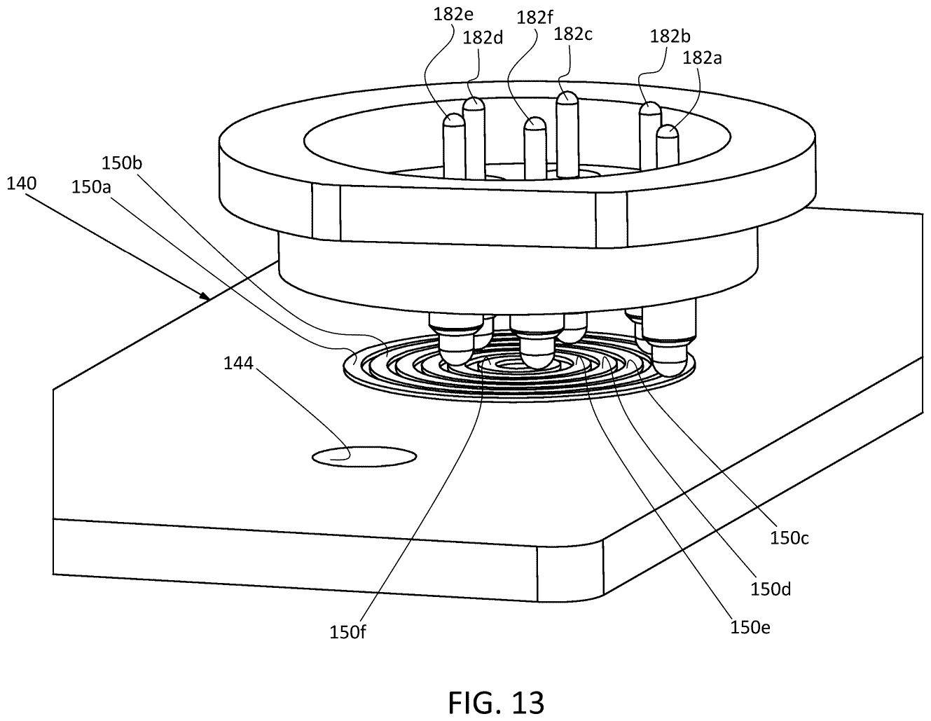

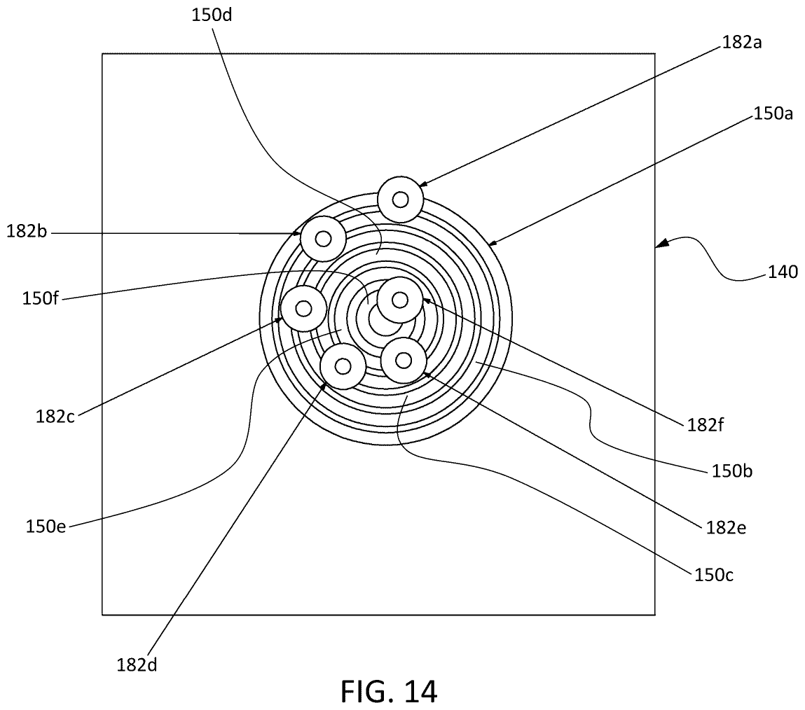

As best seen in FIGS. 7, 13, and 14, and with continued reference to FIGS. 1-6, the shroud 108 houses a circuit board 140, which is secured by threaded fasteners 142 passing through clearance openings 144 in the circuit board 140 and through clearance openings 148 in the housing 110 of the shroud 108. The threaded fasteners 142 engage complementary tapped openings 152 in an interface socket bezel 154. The bezel 154 incudes a central aperture 156 which is aligned with an aperture 148 in the housing 110. The bezel 154 carries the slotted or notched bayonet locking collar 136. The bezel 154 and the housing 110 cooperate to define the interface socket 124. The outward facing surface of the circuit board 140 includes a plurality of concentric annular, e.g., circular, electrical contacts 150a-150f that are aligned with the aperture 148 in the housing 110 and the aperture 156 in the bezel 154.

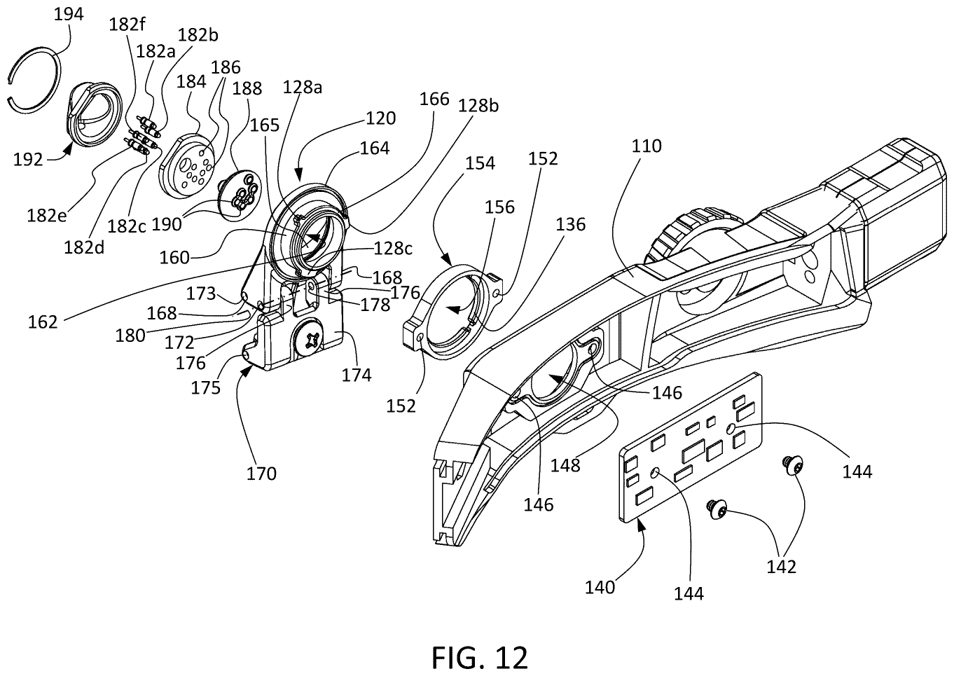

Referring now to FIG. 12, and with continued reference to FIGS. 1-7, 13, and 14, the interface plug 120 comprises a generally cylindrical stub 160, which defines a central bore 162 and having a flange portion 164 at or near a proximal end thereof. The flange portion defining a counterbore 165 coaxially aligned with the bore 162. A lug collar 166 is disposed at or near a distal end of the stub 160 and carries the lugs 128a-128c.

The interface plug 120 further includes a pivoting earpiece interconnect member 170 hingedly attached thereto. A pair of opposing, spaced apart outer arms 168 extend from the flange 164, each arm 168 having a first pivot hole 172. A pair of opposing, spaced apart inner arms 176 extend from a main body portion 174 of the interconnect member 170, each having an aligned inner pivot hole 178. Each pair of the pivot holes 172, 178 receives a pivot pin 181 (see FIG. 4) which defines a pivot axis 180. Each arm 168 further includes a second pivot hole 173 in connection with an carpiece pressure adjustment mechanism as described below.

Electrical contact pins 182a-182f pass through respective aligned openings 186 in a pin insulator 184, which is formed of an electrically insulating material. A pin gasket 188 is disposed over the pin insulator 184 and includes aligned openings 190 for allowing a respective one of the electrical contact pins 182a-182f to pass through. The pin gasket 188 may be formed of an elastomeric material such as silicone, rubber, or other elastomeric polymer. In embodiments, the openings in the pin gasket 188 form a tight seal around the pins 182a-182f to provide environmental sealing against moisture, dust, or other potentially harmful elements. The pins 182a-182f are positioned and aligned so as to establish electrical connections with the contact pads 150a-150f, respectively. The contact pads 150a-150f, in turn, are electrically coupled to the relevant subsystems or functionalities within the helmet accessory mount platform.

In the illustrated exemplary embodiment, the contacts 150a-150f and the respective pins 182a-182f are configured to transmit power and data signals between the headset assembly 112 and the shroud 108. In certain embodiments, the pins 182a-182f are spring loaded telescoping pins, e.g., pogo pins. In certain embodiments, the contacts 150a-150f and the respective pins 182a-182f correspond to SHIELD, CC, VBUS, D+, D−, and GND. The SHIELD serves to provide shielding against electromagnetic interference (EMI) and/or radio-frequency interference (RFI). The CC (configuration channel) enables devices to negotiate power requirements and data roles, detect attachment, and so forth. The VBUS (voltage bus) carries the electrical power required for the operation of the headset assembly 112. The D+ (data positive) contact handles the transmission of positive data signals and the D− (data negative) contact handles the transmission of negative data signals. The GND connection provides a pathway for electrical currents to dissipate. In certain embodiments, the interface 130 adheres to the Universal Serial Bus (USB) 2.0 protocol.

A pin cap 192 is disposed over the pins 182a-182f. A retaining spring clip fastener 194 is provided to retain the pin cap 192, pins 182a-182f, pin insulator 184, and pin gasket 188 within counterbore 165 of the interface plug 120. In embodiments, the retaining spring clip fastener 194 is an internal spring clip which is received within a groove (not shown) formed within the counterbore 165.

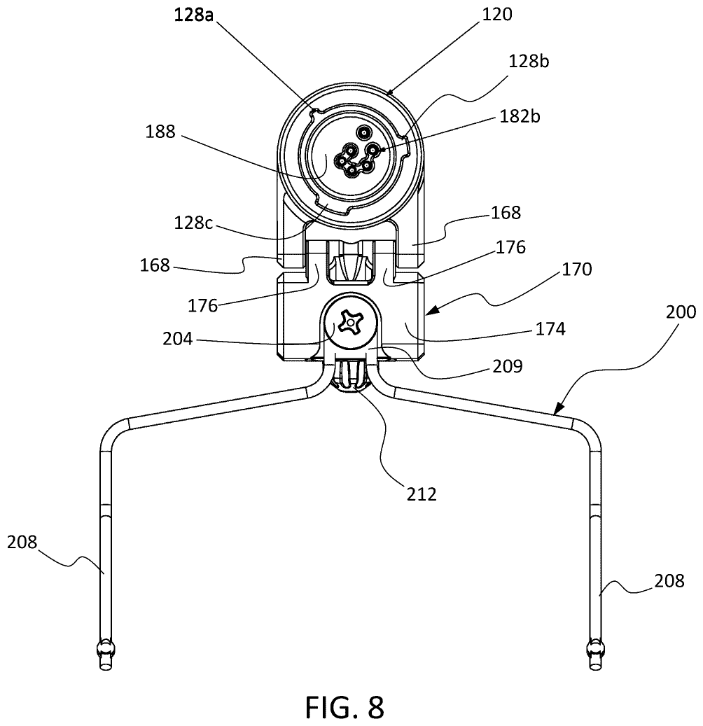

Referring now to FIG. 8 and with continued reference to FIGS. 1-7 and 12-14, there is shown the headset assembly 112 with the carpiece 122 removed. A yoke includes a pair of opposing legs 208 and a generally U-shaped fastening prong 209. The yoke 200 is secured to the main body portion 174 of the interconnect member 170 via a threaded fastener 204 passing through the prong 209. In embodiments, the yoke 200 is formed of a wire material although other materials are contemplated.

A thumb screw 212 is disposed in the main body 174 and provides an adjustment mechanism for selectively increasing or decreasing the pivot angle between the interface plug 120 and the interconnect member 170, thereby allowing the user to selectively increase or decrease the pressure of the earpiece 122 against the user's car/head. The lower or distal end of each leg 208 includes an earpiece attachment member 222 for attaching the carpiece 122.

In certain embodiments, and as best seen in FIG. 4, the pivot adjustment mechanism includes a first pivot member 202 carried on the main body 174 of the interconnect member 170 which pivots about a pivot axis 206, which is parallel to the pivot axis 180. Pivot pins 205 pivotally secure the first pivot member 202 to the interconnect member 170 via the openings 175 (see FIG. 12). The first pivot member 202 includes an enlarged portion or boss 210 along its length, which features a perpendicular bore receiving the shaft of the thumbscrew 212. The perpendicular bore is designed to rotatably capture the thumb screw 212.

A second pivot member 214 is carried on the outer arms 168 of the interface plug 120 which pivots about a pivot axis 226, which is parallel to the pivot axes 180 and 206. The second pivot member 214 is pivotally attached to the outer arms 168 via pivot pins 225 engaging the openings 173 (see FIG. 12).

The second pivot member 214 includes an elongated or protruding boss 218 which features a perpendicular bore threadably receiving the shaft of the thumbscrew 212. Rotatably advancing the thumbscrew 212 within the boss 218 decreases the distance between the axis 206 and the axis 226, causes pivoting movement interconnect member 170 away from the user's head about the axis 180, thereby reducing the pressure exerted by the earpiece 122 against the head of the user. Rotatably retracting the thumbscrew 212 with respect to the boss 218 increases the distance between the axis 206 and the axis 226, causes pivoting movement of the interconnect member 170 toward the user's head about the axis 180, thereby increasing the pressure exerted by the earpiece 122 against the head of the user. That is, manual rotation of the thumbscrew 212 in a first direction pivots the interconnect member about the pivot axis 180 toward the user's head, thereby increasing the pressure of the carpiece 122 against the user's head and, conversely, manual rotation of the thumb screw 212 in a second direction opposite the first direction pivots the interconnect member about the pivot axis 180 away from the user's head, thereby decreasing the pressure of the carpiece 122 against the user's head.

Referring now to FIG. 9, and with continued reference to FIGS. 1-8 and 10-14, there is shown an enlarged view of the coupling interface 130 when the headset assembly 112 in the inverted, attach/detach orientation as shown in FIG. 4.

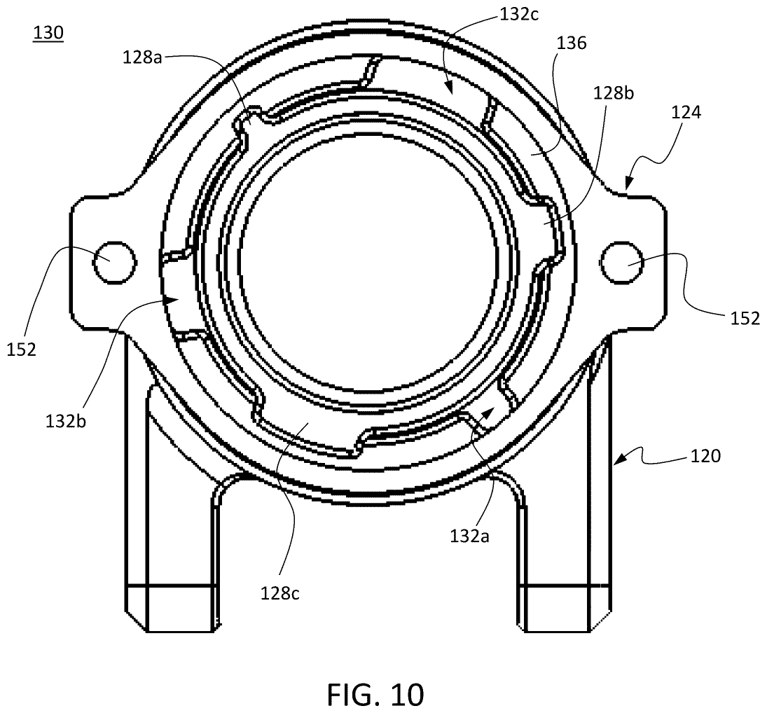

Referring now to FIG. 10, and with continued reference to FIGS. 1-9 and 11-14, there is shown an enlarged view of the coupling interface 130 when the headset assembly 112 is in the deployed position as shown in FIG. 2.

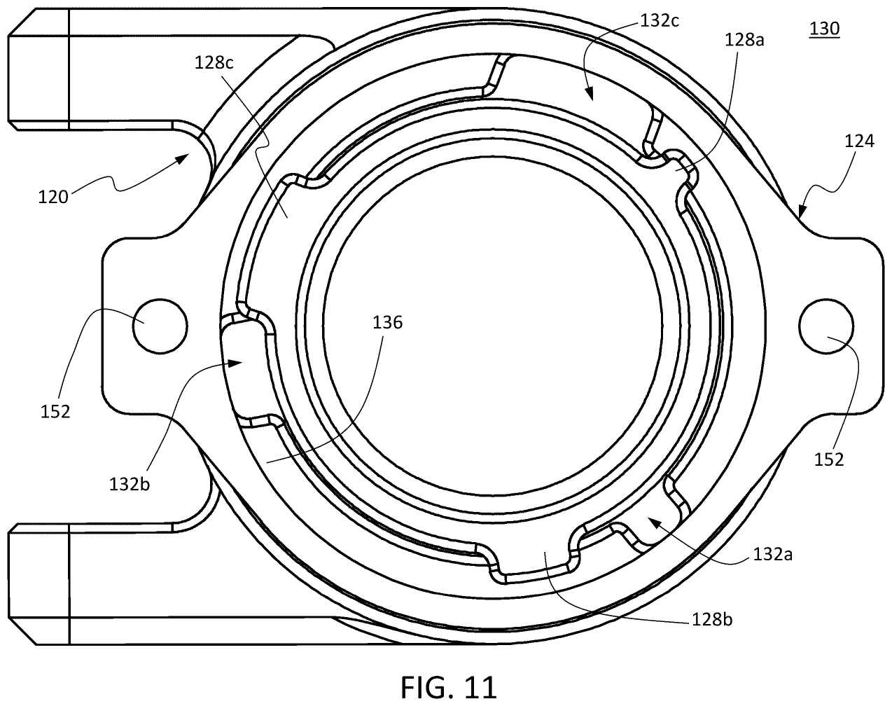

Referring now to FIG. 11, and with continued reference to FIGS. 1-10 and 12-14, there is shown an enlarged view of the coupling interface 130 when the headset assembly 112 is in the deployed position as shown in FIG. 6.

Referring now to FIG. 15, and with continued reference to FIGS. 1-14, the side shroud 108 comprises the circuit board 140 and an interface 127 to the modular helmet accessory platform 100. The platform interface 127 is in communication with a control unit 146, e.g., a microcontroller. The control unit 146, in turn, is in communication with an operator interface 158. In certain embodiments, the control unit 146 may also handle other functions of the helmet accessory platform 100, such as flashlight functionality.

The operator interface 158 may include, for example, one or more user operable actuators, such as a rotary encoder 196, button controls 198, or the like. Other actuator types are also contemplated, such as a magnetic encoder.

In embodiments, a power negotiator circuit or subsystem 216 is coupled to the control unit 146 for facilitating power management with the headset assembly 112. In embodiments, a digital audio interface 220 is provided to receive an audio data stream, e.g., from the helmet mount accessory platform 100. Audio data is then sent to the headset assembly 112 via the headset positioning assembly 116 and the plug 120 and socket 124 interface. In optional embodiments, an RF antenna 228 is provided in the side shroud 108. In embodiments, the antenna 228 is coupled to a wireless transceiver module present at a remote location on the helmet accessory platform 100. In embodiments, an optional high-speed, low-latency interface 246 is coupled to the interface socket 124.

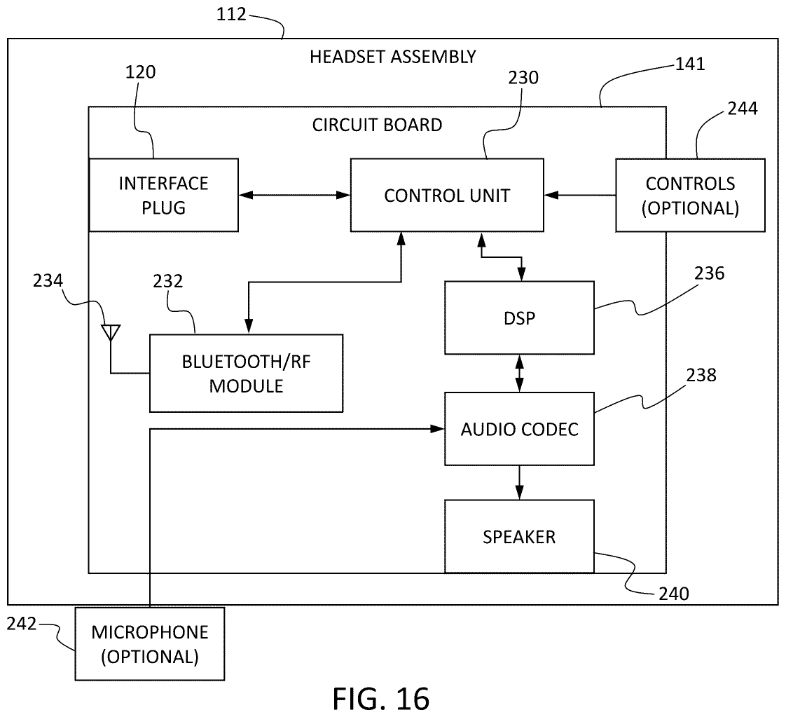

Referring now to FIG. 16, and with continued reference to FIGS. 1-15, an exemplary headset communication system is illustrated. The illustrated communication system and description provided herein are intended for explanatory and illustrative purposes only and it is expressly understood that the present development is not limited to the exact configurations and components depicted. The disclosed embodiment is presented as an exemplary implementation to enable persons skilled in the art to understand and practice the principles of the invention.

The interface plug 120 connector is coupled to a circuit board 141 within the headset assembly 112 and serves as a primary interface to the shroud 108, allowing for both digital audio transmission and input of power from an external power supply. The power supply is advantageously a remote battery pack associated with the helmet accessory attachment system of which the side shroud 108 is a part.

The interface plug 120 is operably coupled to a computer-based control unit 230 which may be microcontroller, microprocessor, or the like. The control unit 230 manages and coordinates the functionalities of the headset. The term control unit 230 as used herein is intended to encompass a processing unit operably coupled to an associated memory, the associated memory configured to store and facilitate the execution of executable program instructions by the control unit 230.

In embodiments, a wireless communications interface 232, such as a Bluetooth module or other radio frequency (RF) transceiver module, is operably coupled to the control unit 230 to facilitate wireless communication. In embodiments, the wireless communications interface 232 is a Bluetooth module to enable the headset to connect to Bluetooth-enabled devices. The wireless communications interface 232 includes an antenna 234.

In embodiments, a digital signal processor (DSP) 236 is provided to enhance audio quality by processing digital audio signal. In embodiments, the DSP 236 is configured to provide one or more features, such as noise reduction, noise cancellation, equalization, audio optimization, and so forth.

In embodiments, an audio codec 238 converts digital audio signals to analog audio signals for output to a speaker 240, which, in turn, converts the analog audio signals into human-audible output. The headset assembly 112 may optionally include a microphone 242 for capturing acoustic input and converts it to an electrical signal which is transmitted to the audio codec 238. In alternative embodiments, the microphone 242 is omitted and acoustic input from the user is captured by an external microphone, such as a microphone associated with a helmet communication system integrated with the helmet 104 or a microphone disposed elsewhere on the helmet accessory attachment platform.

In embodiments, optional manual controls 244 are provided. The control 244 may comprise one or more buttons, dials, or keys for controlling one or more settings of the headset assembly, such as increasing and decreasing volume.

The functions described herein may be implemented using various technologies, including hardware, software, and firmware. Hardware implementations may involve dedicated electronic circuits, processors, or programmable logic devices. Software implementations may utilize computer-executable instructions executed by a processor, while firmware implementations may involve a combination of both hardware and software stored in non-volatile memory. The functions described herein may be implemented in common or separate hardware components. Common hardware implementations involve the integration of multiple functions within a single physical device or system. Separate hardware implementations may distribute the functions across distinct components or devices, providing modularity and design flexibility.

The invention has been described with reference to the preferred embodiment(s). Modifications and alterations will occur to others upon a reading and understanding of the preceding detailed description. It is intended that the invention be construed as including all such modifications and alterations insofar as they come within the scope of the appended claims or the equivalents thereof.

What is claimed is:

1. A headset mounting system, comprising:
a side shroud configured to be attached to a side of a helmet, the side shroud including a mounting receptacle;
a headset assembly having a mounting plug, the mounting plug configured to be detachably coupled to the mounting receptacle, the mounting plug comprising a cylindrical stub having one or more lugs;
a retaining collar disposed within the mounting receptacle, the retaining collar having one or more slots formed therein;
wherein at least a portion of the mounting plug is configured to fit within the collar of the receptacle when the one or more lugs are aligned with the one or more slots; and
wherein the plug is configured to be rotated within the collar so that the one or more lugs engage behind the collar, thereby securing the plug within the receptacle.

2. The headset mounting system of claim 1, wherein the headset assembly includes a yoke having a proximal end coupled to the mounting plug and a distal end coupled to an earpiece.

3. The headset mounting system of claim 1, wherein the plug is pivotable about an axis that is disposed above an ear of a user when donned by the user.

4. The headset mounting system of claim 3, wherein the plug is configured to rotate between a first position wherein the one or more lugs are aligned with the one or more slots and a second position wherein the earpiece is in a deployed position at least partially covering an ear of the user when donned by the user.

5. The headset mounting system of claim 4, wherein the plug is configured to rotate between said second position and a third position wherein the earpiece is stowed adjacent a rear portion of the helmet which is generally above and behind the ear of the user when donned by the user.

6. The headset mounting system of claim 4, wherein said one or more lugs comprise first, second, and third lugs and said one or more slots comprise first, second, and third slots, wherein the first lug is configured with a geometry complementary with a geometry of the first slot, the second lug is configured with a geometry complementary with a geometry of the second slot, and the third lug is configured with a geometry complementary with a geometry of the third slot.

7. The headset mounting system of claim 1, further comprising a helmet structure configured to protect a head of a user.

8. The headset mounting system of claim 1, wherein the side shroud is a component of a helmet accessory mounting platform.

9. The headset mounting system of claim 1, wherein the earpiece is a circumaural ear cup.

10. The headset mounting system of claim 1, further comprising:
a circuit board received within the side shroud, the circuit board having a plurality of concentric, circular electrical contacts disposed within the mounting receptacle;
a plurality of electrical contact pins disposed within the mounting plug; and
wherein each electrical contact pin is positioned to contact and traverse along a respective one of the concentric, circular electrical contacts during pivoting movement of the mounting plug in relation to the mounting receptacle.

11. The headset mounting system of claim 1, wherein the headset assembly includes:
a pivoting interconnect member pivotally attached to the mounting plug;
a yoke attached to pivoting interconnect member;
an earpiece attached to the yoke; and
wherein the pivoting interconnect member is pivotal about a first axis to move the earpiece toward and away from an ear of a user when donned by the user.

12. The headset mounting system of claim 11, further comprising a pivot adjustment mechanism, the pivot adjustment mechanism comprising:
a first pivot member pivotally attached to the pivoting interconnect member, the first pivot member is pivotal about a second pivot axis, the first pivot member receiving a captured, manually rotatable thumbscrew;
a second pivot member pivotally attached to the mounting plug and pivotal about a third pivot axis parallel to the first and second pivot axes, the second pivot member having an elongated boss; and
the thumbscrew including a threaded rod threadably engaging a tapped opening in the elongated boss, wherein rotating the thumbscrew in a first direction causes pivoting movement of the pivoting interconnect member to decrease a pressure of the earpiece on the user when donned by the user and wherein rotating the thumbscrew in a second direction opposite the first direction causes pivoting movement of the pivoting interconnect member to increase a pressure of the earpiece on the user when donned by the user.

13. The headset mounting system of claim 1, wherein the headset assembly includes a computer-based control unit.

14. The headset mounting system of claim 13, wherein the headset assembly further comprises an audio codec operably coupled to the control unit and an audio speaker.

15. The headset mounting system of claim 13, wherein the headset assembly further comprises one or more of a digital signal processor, a wireless communications interface, one or more manual controls, and a microphone.

16. The headset mounting system of claim 15, wherein the wireless communications interface comprises a Bluetooth transceiver module.

17. In a helmet communications system, a headset mounting interface, comprising:
a mounting receptacle;
a mounting plug configured to be detachably coupled to the mounting receptacle, the mounting plug comprising a cylindrical stub having one or more lugs;
a retaining collar disposed within the mounting receptacle, the retaining collar having one or more slots formed therein;
wherein at least a portion of the mounting plug is configured to fit within the collar of the receptacle when the one or more lugs are aligned with the one or more slots;
wherein the plug is configured to be rotated within the collar so that the one or more lugs engage behind the collar, thereby securing the plug within the receptacle.

18. The headset mounting interface of claim 17, further comprising:
a plurality of concentric, circular electrical contacts disposed within the mounting receptacle;
a plurality of electrical contact pins disposed within the mounting plug; and
wherein each electrical contact pin is positioned to contact and traverse along a respective one of the concentric, circular electrical contacts during pivoting movement of the mounting plug in relation to the mounting receptacle.
